(19) United States
(12) Patent Application Publication
(10) Pub. No.: US 2002/0186618 A1
(43) Pub. Date: Dec. 12, 2002

(54) Network-enabled alarm clock

(76) Inventor: Kevin L. Kirkpatrick, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/876,748

(22) Filed: Jun. 7, 2001

(51) Int. Cl. G04B 47/06

(52) U.S. Cl. 368/11

(57) ABSTRACT

The present disclosure relates to a method for controlling an alarm clock. The method comprises the steps of receiving an identification of a date and time at which an alarm is desired, storing the received date and time, and transmitting the date and time to a control module of the alarm clock via a network such that the control module can configure the alarm clock to sound the alarm at the desired date and time. The present disclosure also relates to a method for operating an alarm clock. The method comprises the steps of receiving an alarm schedule sent from a remote location via a network, storing the alarm schedule, enabling the alarm schedule, and emitting an alarm according to the alarm schedule.

### FIELD OF THE INVENTION

The present disclosure relates to a network-enabled alarm clock. More particularly, the disclosure relates to an alarm clock that can be remotely programmed and which is capable of emitting customized alarms obtained via a network, for example but not limited to, such as the Internet.

### BACKGROUND OF THE INVENTION

Alarm clocks have changed little over the past several decades. They typically comprise an alarm capability with which the user can set an alarm to sound at a particular time of the day. Normally, modem alarm clocks allow the user to either select to wake to a default alarm sound, e.g., a series of beeps, which the alarm clock is adapted to emit, or an audio transmission from a radio station, a cassette tape, a compact disk, etc.

Although such alarm clocks function adequately well, much greater flexibility could be provided to the user. For instance, conventional alarm clocks must be set locally. Therefore, where the user decides to schedule an important morning appointment, he or she must remember to set the alarm clock when he or she arrives at home. Where the appointment is scheduled well in advance of its occurrence, it is possible for the user to forget to set his or her alarm clock the night before the appointment. Hence, the user may oversleep.

In addition to having to remember to set the alarm at home, other drawbacks exist. For example, the user is normally provided with few options as to what alarm will sound. Although many modem alarm clocks include radios, compact disk players, and the like, the user's choices are still limited to a standard alarm sound, local radio, and songs and other audio data that he or she possesses in the appropriate medium (e.g., CD). This is unfortunate in that so much more information is available from other sources such as the Internet, none of which can be used by conventional alarm clocks.

From the foregoing, it can be appreciated that it would be desirable to have network-enabled alarm clock that can be programmed remotely and/or that can receive audio data from a network such as the Internet for use as an alarm.

### SUMMARY OF THE INVENTION

The present disclosure relates to a method for controlling an alarm clock. The method can be broadly summarized by the following steps: receiving an identification of a date and time at which an alarm is desired, storing the received date and time, and transmitting the date and time to a control module of the alarm clock via a network such that the control module can configure the alarm clock to sound the alarm at the desired date and time.

The present disclosure also relates to a method for operating an alarm clock. The method comprises the steps of receiving an alarm schedule sent from a remote location via a network, storing the alarm schedule, enabling the alarm schedule, and emitting an alarm according to the alarm schedule.

The present disclosure further relates to a system for controlling an alarm clock, comprising means for receiving an identification of a date and time at which an alarm is desired, means for storing the received date and time, and means for transmitting the date and time to a control module of the alarm clock via a network such that the control module can configure the alarm clock to sound the alarm at the desired date and time.

In addition, the present disclosure relates to a system for operating an alarm clock, comprising means for receiving an alarm schedule sent from a remote location via a network, means for storing the alarm schedule, means for enabling the alarm schedule, and means for emitting an alarm according to the alarm schedule.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a system for operating a network-enabled alarm clock.

FIG. 2 is a schematic view of the architecture of a network-enabled alarm clock shown in FIG. 1.

FIG. 3 is a schematic perspective view of an example physical configuration of the network-enabled alarm clock of FIG. 2.

FIG. 4 is a schematic view of the architecture of a network server shown in FIG. 1.

FIG. 5 is a flow diagram that illustrates functionality and operation of a control module shown in FIG. 2.

FIG. 6 is a flow diagram that illustrates functionality and operation of a remote control module shown in FIG. 4.

### DETAILED DESCRIPTION

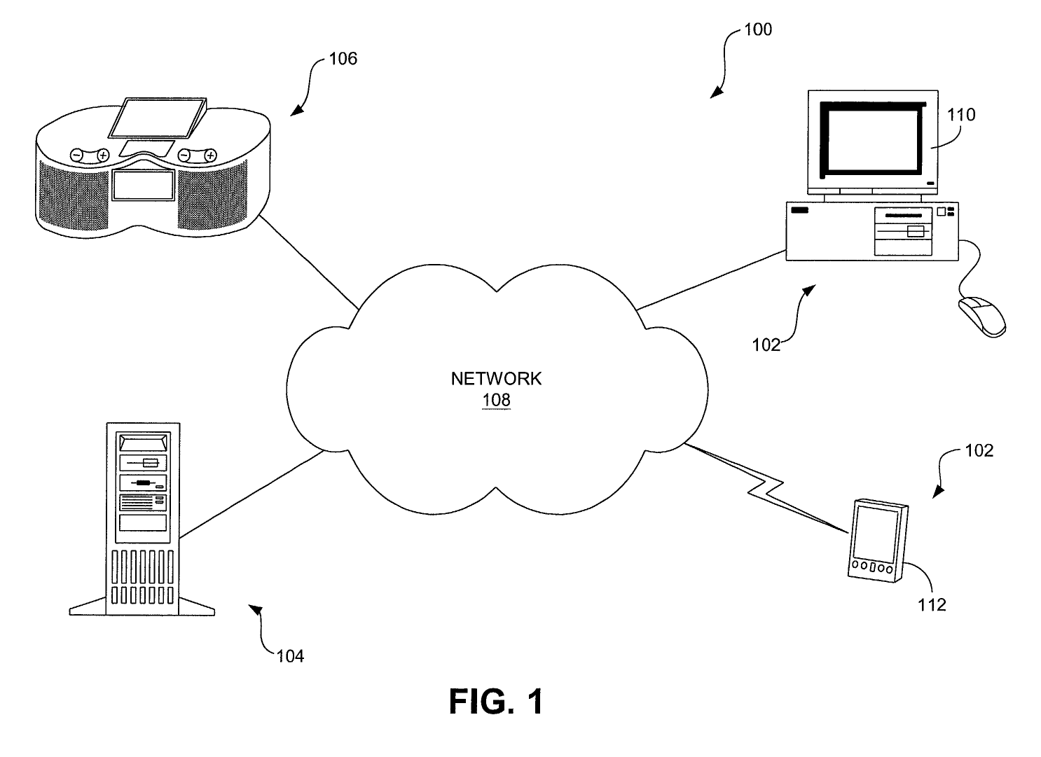

Referring now in more detail to the drawings, in which like numerals indicate corresponding parts throughout the several views, FIG. 1 illustrates a system 100 for operating a network-enabled alarm clock. As indicated in this figure, the system 100 can comprise one or more computing devices 102, at least one network server 104, and a network-enabled alarm clock 106. Each of these components is connected to a network 108 that preferably comprises the Internet.

By way of example, the computing devices 102 can comprise a desktop personal computer (PC) 110 and/or a personal digital assistant (PDA) 112. Although these devices are shown in FIG. 1 for purposes of example, it will be understood that the computing devices 102 can comprise other configurations. Indeed, as will be apparent from the discussion that follows, the particular configuration of the computing device 102 used is unimportant. More important is that the computing device 102 is in some way connected to the network 104 (directly or wirelessly) and that it is capable of transmitting data across and/or receiving data from the network 108. As is described below, the computing devices 102 can be used to control the operation of the network-enabled alarm clock 106 and, if desired, customize its operation through utilization of the network 108. In the latter situation, audio data is transmitted to the alarm clock 106 from at least one network server 104.

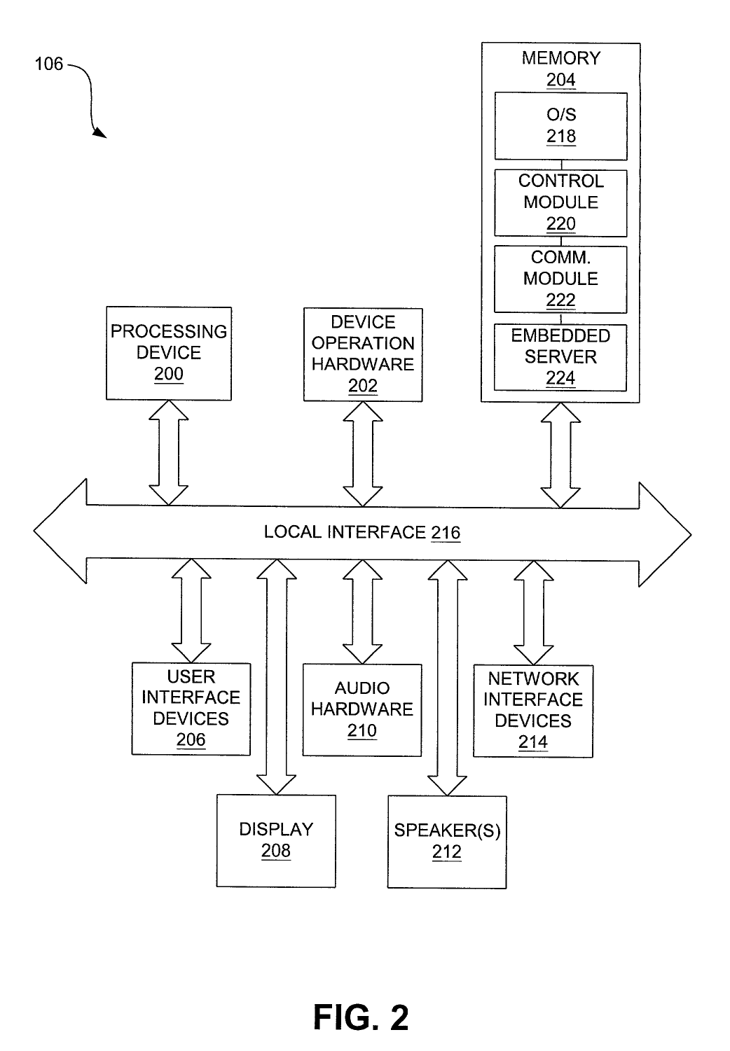

FIG. 2 is a schematic view illustrating an example architecture for the network-enabled alarm clock 106 shown in FIG. 1. As indicated in FIG. 2, the alarm clock 106 generally comprises a processing device 200, device operation hardware 202, memory 204, user interface devices 206, a display 208, audio hardware 210, at least one speaker 212, network interface devices 214, and a local interface 216 to which each of the other components electrically connects. The processing device 200 is adapted to execute commands stored in memory 204 and can comprise a general-purpose processor, a microprocessor, one or more application-specific integrated circuits (ASICs), a plurality of suitably configured digital logic gates, and other known electrical configurations comprising discrete elements both individually and in various combinations to coordinate the overall operation of the network-enabled alarm clock 106. The device operation hardware 202 comprises the various components used to operate the alarm clock 106 including keeping time and scheduling alarms. The user interface devices 206 comprise interface tools with which the settings of the alarm clock 106 can be changed and through which the user can communicate basic commands to the alarm clock.

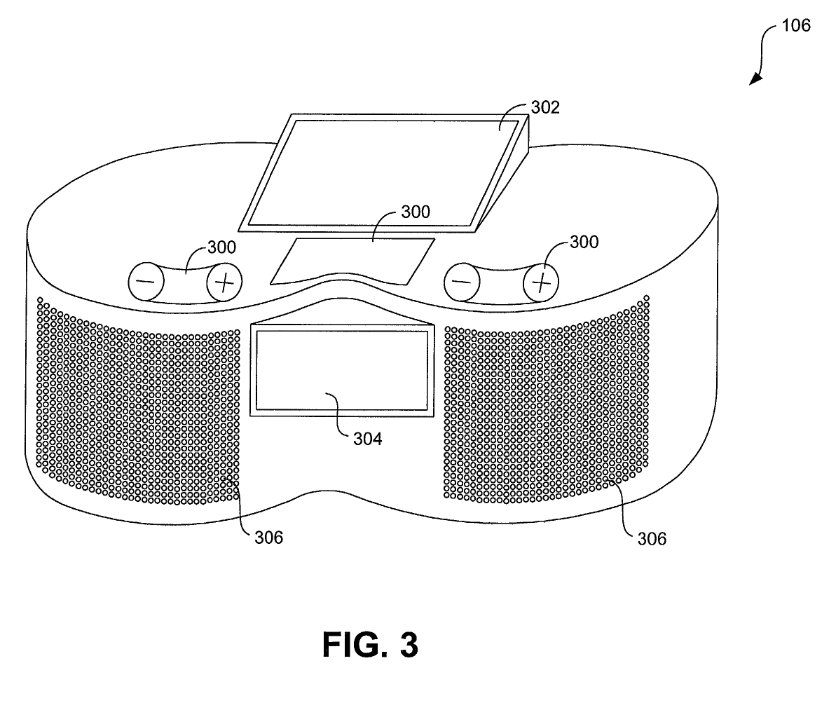

FIG. 3 illustrates an example physical configuration of the network-enabled alarm clock 106. As indicated in this figure, the interface devices 206 referenced in FIG. 3 can comprise one or more function keys 300 with which the operation of the network-enabled alarm clock 106 can be controlled. By way of example, the keys 300 can include a power button, snooze button, radio tuning button, volume control button, and other such buttons typically provided on an alarm clock. As will be appreciated by persons having ordinary skill in the art, the specific number and nature of the function keys 300 will vary depending upon the functionalities desired. Preferably, however, few such function keys 300 are provided to maintain the simplicity of the operation and look of the network-enabled alarm clock 106.

In addition to the function keys 300, the user interface devices 206 can include a touch-sensitive display 302 which, as is discussed below, can be used to program the alarm clock 106. By way of example, the display 302 can comprise a touch-sensitive liquid crystal display (LCD). When provided, the display 302 can serve as the display 208 identified in FIG. 2. In addition or alternatively, the network-enabled alarm clock 106 can comprise a further LCD or a light emitting diode (LED) display 304 which is used to convey information to the user, such as the time, tuned frequency of a radio station, and the like. As will be appreciated by persons having skill in the art, the display 304 may not be necessary where the alarm clock 106 includes a touch-sensitive display 302 in that this information could, optionally, be presented with the display 302. However, provision of both displays may be preferable to facilitate both easy programming of the alarm clock and easy reading of the time.

With reference back to FIG. 2, the audio hardware 210 comprises the basic components necessary to generate sounds. Accordingly, the audio hardware 210 can include components used to receive amplitude modulated (AM) and frequency modulated (FM) radio signals, a cassette player, a compact disk (CD) player, a sound card, etc. In any case, the alarm clock 106 preferably includes one or more speakers 212 that are used to emit the sound generated by the audio hardware 210. As indicated in FIG. 3, these speakers 212 can comprise speakers 306 provided on the front side of the alarm clock 106.

Returning to FIG. 2, the network interface devices 214 are adapted to facilitate communications across the network 108 (e.g., Internet) and therefore can comprise a modem or other data transmitting/receiving device. Optionally, the network interface devices 214 can be adapted for wireless communication. Where wireless communication is used, omnidirectional communication is preferred such as radio frequency (RF) transmission and reception via Bluetootht™ from Bluetooth SIG™ and/or 802.11 protocol in compliance with institute of electrical and electronics engineers (IEEE) specifications. In any case, the network interface devices 214 are adapted to receive remote commands that control the operation of the alarm clock 106 and, optionally, receive data used in serving the alarm clock functionality.

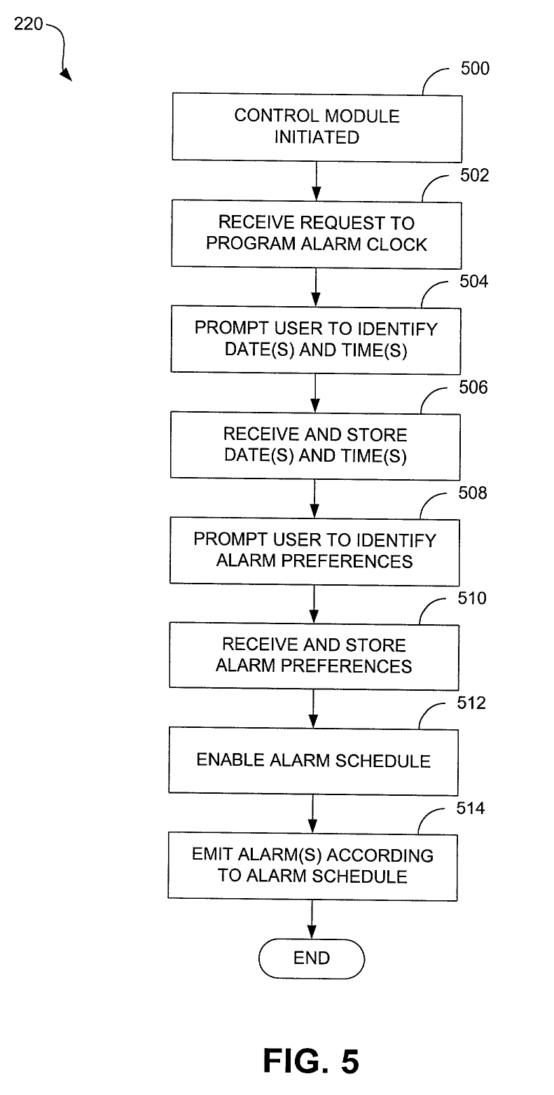

The memory 204 includes an operating system 218, a control module 220, a communications module 222, and, optionally, an embedded network server 224. The operating system 218 contains the various commands used to control the general operation of the network-enabled alarm clock 106. The control module 220 comprises software and/or firmware that is adapted to receive commands entered by the user either locally at the alarm clock 106 or remotely with a computing device 102. The control module 220 then executes these commands such that the operation of the network-enabled alarm clock 106 is controlled. The operation of the control module 220 is described in greater detail in relation to FIG. 5 below. The communications module 222 comprises software and/or firmware that is adapted to, in conjunction with the network interface devices 214, facilitate communications over the network 108 such that commands and data can be received by the alarm clock 106 via the network. When provided, the embedded network server 224 comprises software and/or firmware configured to generate a network page (e.g., web page) accessible over the network 108 that can be used to deliver user commands to the control module 220.

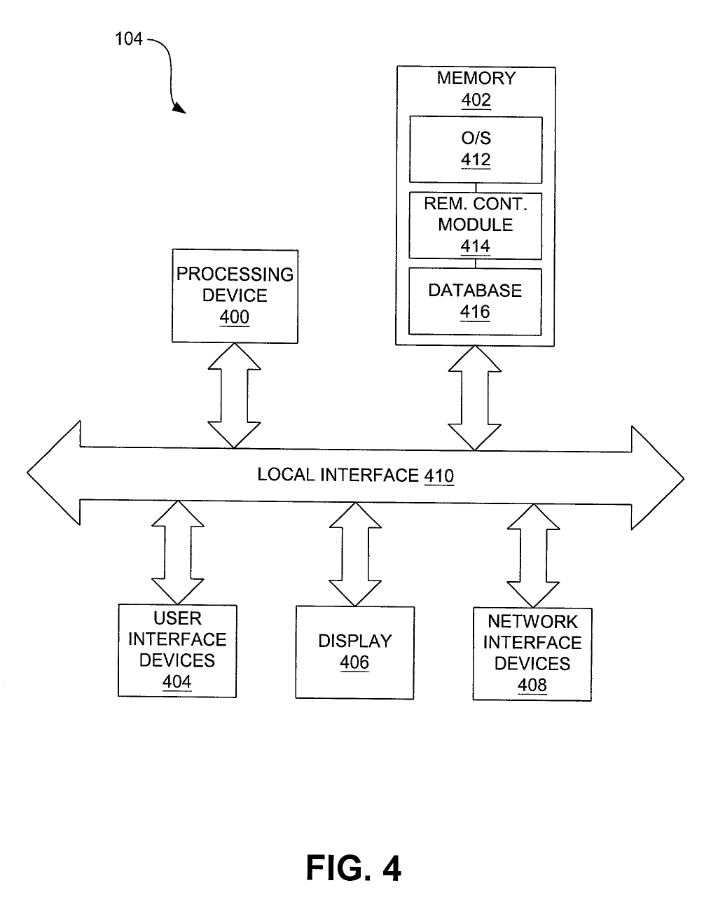

FIG. 4 is a schematic view illustrating an example architecture for the at least one network server 104 shown in FIG. 1. As indicated in FIG. 4, the network server 104 generally comprises a processing device 400, memory 402, user interface devices 404, a display 406, and network interface devices 408. Each of these components is connected to a local interface 410 that, by way of example, comprises one or more internal buses. The local interface 410 may have additional elements, which are omitted for simplicity, such as controllers, buffers (caches), drivers, repeaters, and receivers, to enable communications. Furthermore, the interface 410 may include address, control, and/or data connections to enable appropriate communications among the aforementioned components.

The processing device 400 comprises hardware for executing software that is stored in memory 402 and can include any custom made or commercially available processor, a central processing unit (CPU) or an auxiliary processor among several processors associated with the network server 104, a semiconductor based microprocessor (in the form of a microchip), or a macroprocessor. The memory 402 can include any one of combination of volatile memory elements (e.g., random access memory (RAM, such as DRAM, SRAM, etc.)) and nonvolatile memory elements (e.g., ROM, hard drive, tape, CDROM, etc.). Moreover, the memory 402 can incorporate electronic, magnetic, optical, and/or other types of storage media. Note that the memory 402 can have a distributed architecture, where various components are situated remote from one another, but accessible by the processing device 400.

The user interface devices 404 and display 406 typically comprise those normally used in association with a network server 108. For instance, the user interface devices 404 can include a keyboard, mouse, etc., and the display 406 can comprise a monitor. The network interface devices 408 comprise the hardware with which the network server 104 transmits and receives data over the network 108. By way of example, the network interface devices 410 include components that communicate both inputs and outputs, for instance, a modulator/demodulator (e.g., analog, digital subscriber line (DSL), or cable modem), a radio frequency (RF) or other transceiver, a telephonic interface, a bridge, a router, etc.

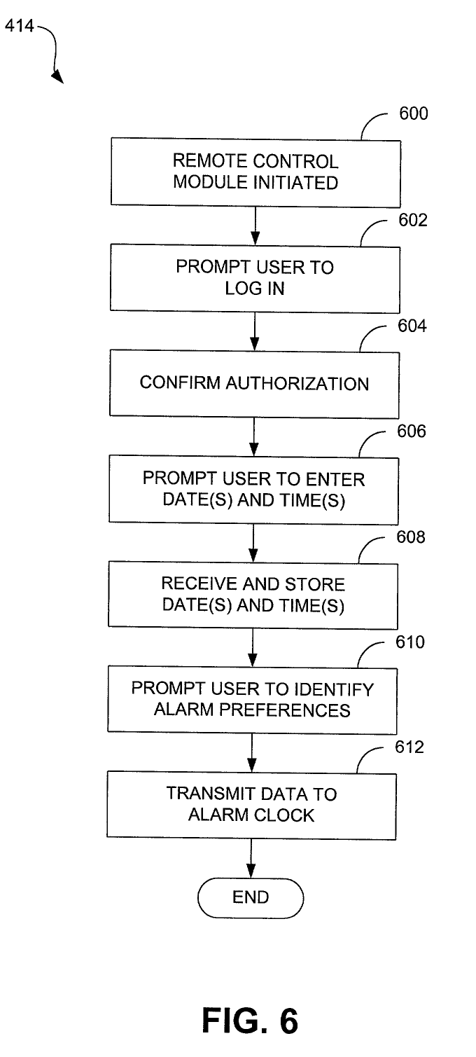

As indicated in FIG. 4, the memory 402 comprises various software programs. In particular, the memory 402 includes an operating system 412 and a remote control module 414. The operating system 412 controls the execution of other software, such as the remote control module 414, and provides scheduling, input-output control, file and data management, memory management, and communication control and related services. The remote control module 414 typically comprises software that is used to generate and maintain a network site (e.g., web site) that, as is discussed below, can be used to remotely control operation of the network-enabled alarm clock 106. The operation of the remote control module 414 is discussed in greater detail below with reference to FIG. 6. In addition to this software, the memory 402 can comprise a database 416 that, as is described below, can be used to store audio data that can be downloaded to the network-enabled alarm clock 106.

Various software and/or firmware modules have been described herein. It is to be understood that these modules can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These modules can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

FIG. 5 illustrates operation of the control module 220 of the network-enabled alarm clock 106. As identified in this figure, the control module 220 is first initiated, as indicated in block 500. As will be appreciated by persons having ordinary skill in the art, this initiation can be accomplished in a variety of ways. For example, the user can press a function key 300 that is dedicated to initiating programming of the network-enabled alarm clock 106. Alternatively, a “soft” key displayed in the touch-sensitive display 302 can be selected (FIG. 3). Regardless, once the control module 220 has been initiated, it can receive a programming request from the user, as indicated in block 502. Normally, this programming request is received via the touch-sensitive display 302. As will be appreciated by persons having ordinary skill in the art, the user can be presented with one or more graphical user interfaces (GUIs) with which commands can be communicated to control module 220. Therefore, the request and other such selections can be facilitated with soft keys, pull-down menus, data fields, and combinations thereof.

After the programming request has been received, the control module 220 can prompt the user to identify a date and time for which the user would like to set an alarm, as indicated in block 504. Due to the provision of the display 302, the user has more flexibility in setting this alarm. For instance, selection of the date and time can be facilitated by the control module 220 by presenting a calendar to the user via the display 302. In such a circumstance, the user can easily select the day he or she would like the alarm to be sounded, as well as the time. Contrary to where a conventional alarm clocked is used, the user has the freedom to set more than one alarm if he or she wishes. Indeed, the user can even chose to set all the alarms that will be sounded during a particular week or substantially any designated period of time. Furthermore, the user can customize the alarms used on any given occasion. For instance, the user can choose two or more sequential alarms, a variable alarm volume, multiple different types of alarms that are used separately or together (e.g., music, alarm sounds, etc.). Therefore, it will be appreciated that the user has great flexibility in designing his or her waking experience.

Once the user enters his or her selections as to the date(s) and time(s), the control module 220 receives and stores this information, as indicated in block 506. At this point, the control module 220 can prompt the user to identify his or her alarm preferences, as indicated in block 508. The choice can simply be between one or more alarm sounds stored within the alarm clock 106 and an audio transmission from a local radio station, cassette player, or CD player, where applicable. In addition, however, due to the fact that the alarm clock 106 is network-enabled, far more possibilities exist. For instance, the user can select to hear a particular song or several songs from a particular artist that the alarm clock 106 retrieves from the network 108 and “plays” for the user at the desired time. Alternatively, the user can select another audio file (e.g., pre-recorded news or sports program) that is downloaded form the network 108. In a further alternative, the user can select to hear a live radio transmission from a remote location (e.g., another city or state) that is streamed to the alarm clock 106 via the network 108. Indeed, the network-enabled alarm clock 106 can be configured to emit substantially any audio data available over the network (e.g., Internet), thereby providing the user with much greater freedom in designing his or her waking experience.

To select audio data to be retrieved via the network 108, the user identifies the location (e.g., Internet protocol address) of the audio data he or she wishes to hear. This selection can be made by navigating a series of menus presented to the user with the display 302. To simplify this process, the control module 220 can be preconfigured to present various directories of audio data that the alarm clock vendor or the user has created at a remote location (e.g., network server 104) on the network 108. In such a situation, the directories are downloaded to the network-enabled alarm clock 106 in an initial registration process, and/or through periodic updates that are received by the alarm clock at designated intervals. In either case, the control module 220 is pre-configured with links to the audio data such that this data can be located and then retrieved.

Once the alarm preferences have been entered, they are received and stored by the control module 220, as indicated in block 510. At this point, the alarm schedule can be enabled, as indicated in block 512. As will be appreciated by persons having ordinary skill in the art, the nature of this enablement depends upon the alarm preferences the user has selected. For instance, where the user has simply chosen an alarm sound stored locally within the alarm clock 106, or the mere activation of the radio, cassette player, or CD player, this only involves coordinating the alarm schedule and facilitating emission of the alarm. Where, however, the user has selected audio data that is to be retrieved from the network 108, the alarm schedule enablement involves interaction with another device (e.g., network server 104) across the network 108. For instance, if the user has selected a particular song to wake to, the control module 220 will, assuming the song is not already stored locally in the alarm clock 106, access a database out on the network, e.g., database 416, retrieve the information desired by the user, and then store it for later transmission to the user via the speakers 306. Where the network-enabled alarm clock 106 is connected to a standard telephone line of the user's home, this retrieval process may occur at a time of day at which the telephone lines are least often used, for example, very late at night or very early in the morning. In this way, interruptions of the home telephone service can be minimized. Normally, the audio data is stored just long enough to be used for the alarm function. Accordingly, the data can be discarded (e.g., written over) thereafter to preserve storage space. Optionally, the data can be retained for later use (e.g., the next day) until such time where the storage space is needed for new audio data.

In another example, where the user wishes to listen to a remote radio show or other streaming audio data, the control module 220 controls the alarm clock 106 such that this data streams to the alarm clock via the network 108 at the time selected by the user. Accordingly, it can be appreciated that the network-enablement of the alarm clock 106 permits the user to wake to substantially any audio data that can be obtained from the network 108.

Once the scheduling and any necessary downloading has been completed by the control module 220, the network-enabled alarm clock 106 can emit the scheduled alarm at the scheduled time, as indicated in block 514. Again, the nature of the alarm emitted depends upon the selections made by the user. It is to be understood that various alarm combinations can be scheduled, if desired. For instance, the user can select to first hear a selected song, followed by a selected alarm sound. Alternatively, if the user has selected to be woken by streaming audio of some sort, the control module 220 can be configured to emit a local alarm sound or downloaded song as a back-up in case there is difficulty in obtaining or transmitting the streaming audio data for some reason. Once the alarm or alarms have sounded, it or they can be shut off by the user and flow is terminated

As identified above, the network-enabled alarm clock 106 can also be programmed remotely. Typically, such remote programming is accomplished through use of a computing device 102 that is used to access a network site (e.g., web site) that is generated and maintained by the remote control module 414 of the network server 104. With reference to FIG. 6, the remote control module 414 is first initiated, as indicated in block 600. This initiation can merely comprise the user accessing the site with the computing device 102. At this point, the remote control module 414 can prompt the user, via the site, to log in, as indicated in block 602. The log in procedure can comprise the entry of a username and password combination as is conventional in the art. By logging in, the user communicates his or her authorization to control operation of the network-enabled alarm clock 106. Once the user enters the log in information, his or her authorization is confirmed, as indicated in block 604.

At this point, programming of the alarm clock is accomplished in similar manner to that described above with respect to FIG. 5. Accordingly, the remote control module 414 can prompt the user to identify a date and time for which the user would like to set an alarm, as indicated in block 606. Again, selection of the date and time can be facilitated by presenting a calendar to the user with which the user can convey the appropriate date and time. Once the user enters his or her selections as to the date(s) and time(s), the remote control module 414 receives and stores this information, as indicated in block 608. The remote control module 414 can then prompt the user to identify his or her alarm preferences, as indicated in block 610. Again, the user has the freedom to select substantially any audio data with which he or she wishes to be woken. By way of example, the web site can comprise one or more directories containing a plurality of links to particular sounds, songs, streaming programs, etc. for the user to choose. In addition, the site can be configured to receive a link (e.g., Internet protocol address) to audio data that he or she would like to hear. By way of example, this information can be received through a data field presented to the user at the site. Accordingly, the user can designate substantially any audio data that can be accessed on the network 108 for use as an alarm.

Once the alarm preferences have been entered, the remote control module 414 transmits data to the network-enabled alarm clock 106, as indicated in block 612. Again, the nature of this transmission depends upon the selections made by the user. Where the user has selected to merely use a local alarm or other audio data stored or accessible in the alarm clock 106, the remote control module 414 will simply convey the alarm schedule. Where, however, the user has selected a audio data which it does not already possess, the transmission may further include transmission of the data or an address that can be used to access the audio data. Operating in this manner, the remote control module 414 can be used to remotely program one's alarm clock and further customize its operation.

In an alternative and/or additional arrangement, all user selections can be made remotely with a computing device 102 by accessing a network page (e.g., web page) generated by the embedded network server 224 identified in FIG. 2. In such a case, selections are made in a similar manner to that described in relation to FIG. 6. Accordingly, operations via the embedded network server 224 are not described in detail herein.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for controlling an alarm clock, comprising the steps of:
receiving an identification of a date and time at which an alarm is desired;
storing the received date and time; and
transmitting the date and time to a control module of the alarm clock via a network such that the control module can configure the alarm clock to sound the alarm at the desired date and time.

2. The method of claim 1, wherein the step of receiving an identification of a date and time comprises receiving the identification via a web site accessible over the Internet.

3. The method of claim 1, further comprising the step of receiving and storing an indication of the type of alarm that is desired to be sounded.

4. The method of claim 3, wherein the alarm comprises a sound that is stored within the alarm clock.

5. The method of claim 3, wherein the alarm comprises audio data obtained from a database remote from the alarm clock.

6. The method of claim 5, further comprising the step of transmitting the audio data to the alarm clock.

7. The method of claim 5, further comprising the step of transmitting an identification of the location of the audio data to the alarm clock such that the alarm clock can retrieve the audio data.

8. A system for controlling an alarm clock, comprising:
means for receiving an identification of a date and time at which an alarm is desired;
means for storing the received date and time; and
means for transmitting the date and time to a control module of the alarm clock via a network such that the control module can configure the alarm clock to sound the alarm at the desired date and time.

9. The system of claim 8, wherein the means for receiving an identification of a date and time comprises means for receiving the identification via a web site accessible over the Internet.

10. The system of claim 8, further comprising means for transmitting audio data to the alarm clock via the network.

11. The system of claim 8, further comprising means for transmitting an identification of a location of audio data to the alarm clock for retrieval by the alarm clock.

12. A method for operating an alarm clock, comprising the steps of:
receiving an alarm schedule sent from a remote location via a network;
storing the alarm schedule;
enabling the alarm schedule; and
emitting an alarm according to the alarm schedule.

13. The method of claim 12, wherein the step of receiving an alarm schedule comprises receiving an alarm schedule transmitted via the Internet.

14. The method of claim 12, further comprising the step of receiving audio data that has been transmitting to the alarm clock via the network.

15. The method of claim 12, further comprising the steps of receiving an identification of the location of audio data and then retrieving the audio data via the network.

16. A system for operating an alarm clock, comprising:
means for receiving an alarm schedule sent from a remote location via a network;
means for storing the alarm schedule;
means for enabling the alarm schedule; and
means for emitting an alarm according to the alarm schedule.

17. The system of claim 16, further comprising means for receiving audio data that has been transmitting to the alarm clock via the network.

18. The method of claim 16, further comprising means for receiving an identification of the location of audio data and means for retrieving the audio data via the network.

19. An alarm clock, comprising:
a processing device;
a memory;
at least one network interface device; and
a control module configured to receive alarm scheduling data sent to the alarm clock from a remote location via a network.

20. The alarm clock of claim 19, wherein the control module is configured to receive audio data sent from the remote location via the network.

21. The alarm clock of claim 19, wherein the control module is configured to retrieve audio data via the network after receiving an identification as to the location of the audio data.

22. The alarm clock of claim 19, further comprising an embedded network server adapted to generate at least one network page with which an alarm can be scheduled by a user.
